(19) United States
(12) Patent Application Publication
(10) Pub. No.: US 2008/0221761 A1
(43) Pub. Date: Sep. 11, 2008

(54) Vehicle control system and component units therefor

(75) Inventor: Toshifumi Shimoda, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/003,909

(22) Filed: Jan. 3, 2008

(30) Foreign Application Priority Data
Mar. 6, 2007 (JP) 2007-56037

(51) Int. Cl. G06F 19/00; G06F 17/00

(52) U.S. Cl. 701/54; 701/1

(57) ABSTRACT

In a vehicle control system, a vehicle unit transmits a smart request signal through its LF transmitter. When a mobile unit receives the smart request signal through its LF receiver, it transmits a response signal through its RF transmitter. The vehicle unit, receiving this response signal though its RF receiver, performs smart control such as door unlocking. The mobile unit further transmits a presence notification signal different from the response signal through its RF transmitter, when a predetermined notification condition is satisfied. The vehicle unit notifies passengers of the vehicle of the presence of the mobile unit, when it receives this notification signal while the predetermined condition is not satisfied.

### CROSS REFERENCE TO RELATED APPLICATION

This application is based on and incorporates herein by reference Japanese Patent Application No. 2007-56037 filed on Mar. 6, 2007.

### FIELD OF THE INVENTION

The present invention relates to a vehicle control system and its component units such as a vehicle unit mounted in a vehicle and a mobile unit carried by a user for radio communications with the vehicle unit.

### BACKGROUND OF THE INVENTION

As a vehicle control system, JP 10-317754 proposes a smart control system, which performs various vehicle controls without requiring manual operation of a user. This control is performed by radio communications between a vehicle unit mounted in a vehicle and a mobile unit such as an electronic key carried by a user.

In this control system, the vehicle unit includes a vehicle-side transmitter and receiver, which performs radio communications in a comparatively narrow predetermined communication area around the vehicle. The vehicle-side transmitter and receiver transmits a request signal and receives a response signal, which is be transmitted from the mobile unit in response to the request signal. This response signal includes an identification (ID) code specifically assigned to the vehicle and the mobile unit. The vehicle unit further includes a controller, which checks whether the mobile unit is an authorized one for the vehicle by comparing the ID code included in the response signal with an ID code registered in the controller of the vehicle unit. The controller performs predetermined vehicle control such as locking and unlocking of vehicle doors, and enabling engine starting, if the compared ID codes agree.

The mobile unit includes a mobile-side transmitter and receiver, which transmits and receives radio signals. The mobile unit further includes an electronic controller, which causes the mobile-side transmitter and receiver to transmit the response signal in response to the request signal received by the mobile-side transmitter and receiver.

The vehicle-side transmitter and receiver and the mobile-side transmitter and receiver are provided exclusively for radio communications between the vehicle unit and the mobile unit of the smart control system. The controller in the vehicle unit may be implemented as one (e.g., security ECU) of various electronic controllers provided in the vehicle.

The operation of the smart control system is generally necessitated only in a predetermined condition, that is, while the engine in the vehicle is stopped and not operated. The controller in the vehicle unit therefore is configured to invalidate the response signal received by the vehicle-side transmitter and receiver, while the engine is in operation.

The smart control system needs the vehicle-side transmitter and receiver and the mobile-side transmitter and receiver only while the vehicle and engine is at rest and not in operation. It is therefore inefficient to provide such transmitters and receivers, which are not used while the engine and the vehicle are in operation.

Vehicles need more and more advanced control systems, which should operate while the engine and the vehicle are in operation. The vehicles thus require more spaces for installing these advanced control systems.

### SUMMARY OF THE INVENTION

It is therefore an object of the present invention to provide a vehicle control system, which reduces required space for installation in a vehicle while maintaining a smart control system.

According to one aspect, a vehicle control system includes a mobile unit carried by a user and a vehicle unit mounted in a vehicle. The mobile unit performs radio communications with the vehicle unit, transmits a predetermined response signal when receiving a predetermined request signal, and transmits a presence notification signal different from the response signal when a predetermined notification condition is satisfied. The vehicle unit also performs radio communication with the mobile unit, transmits the request signal when a predetermined operation condition is satisfied, performs predetermined vehicle control when receiving the response signal in response to the request signal, and performs a notification corresponding to the presence notification signal when receiving the presence notification signal while the predetermined operation condition is not satisfied.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a vehicle control system according to a first embodiment of the present invention;

FIG. 2 is a flowchart showing vehicle control processing executed by a controller in a vehicle unit in the first embodiment;

FIG. 3 is a flowchart showing presence notification control processing, which is a part of processing shown in FIG. 2;

FIG. 4 is a flowchart showing mobile unit control processing executed by a controller in a mobile unit in the first embodiment;

FIGS. 5A and 5B are schematic diagrams showing operations of the first embodiment;

FIGS. 6A to 6D are schematic views showing various operations of the first embodiment; and

FIG. 7 is a schematic diagram showing a sequence of operation of a control system for a vehicle according to a second embodiment of the present invention.

### DETAILED DESCRIPTION OF THE PREFERRED EMBODIMENT

### First Embodiment

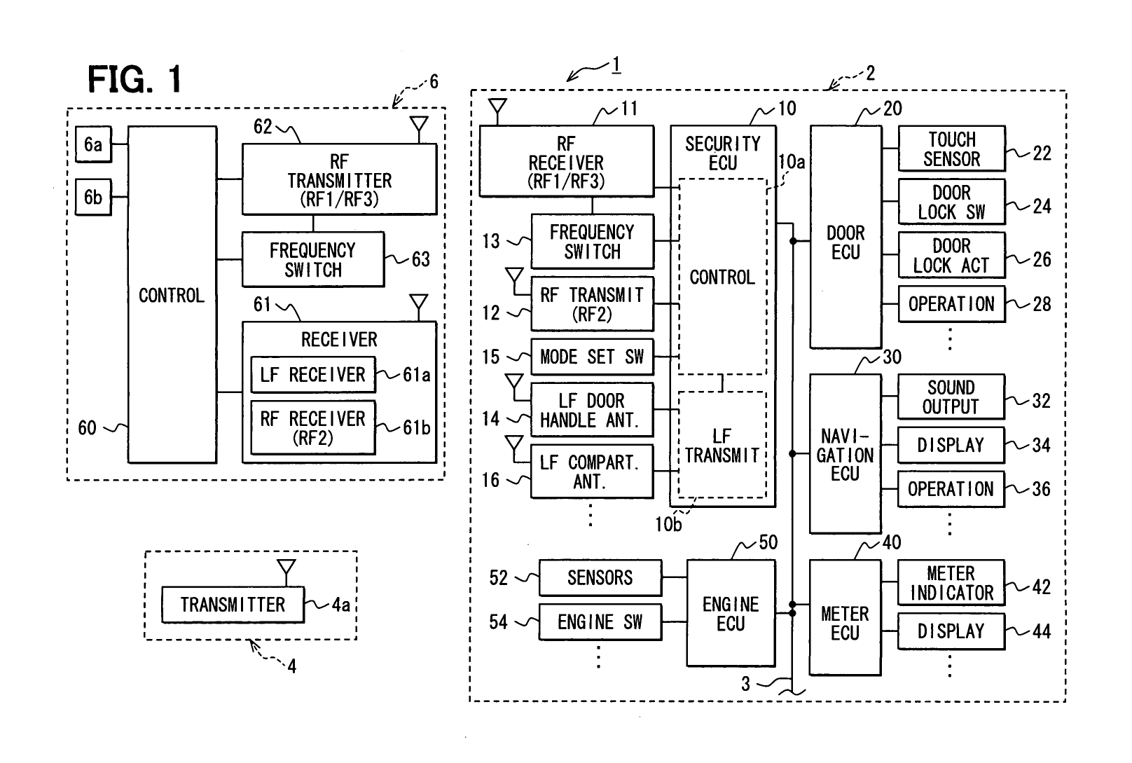

Referring to FIG. 1, a vehicle control system 1 includes a vehicle unit 2 mounted in a vehicle, a mobile unit 6 carried by a vehicle user and operable as an electronic key, and a road unit 4 embedded in a road-side fixture (e.g., guardrail, road post, signal post, night light post) provided at locations such as near intersections, at which traffic accidents often occur.

In the control system 1, the vehicle unit 2 and the mobile unit 6 communicate with each other by transmitting and receiving radio signals therebetween, thereby performing a smart function (smart entry operation) in a conventional manner. In this smart function, the vehicle unit 2 performs predetermined vehicle control (e.g., unlocking of vehicle doors and enabling engine starting) without requiring manual operation of a user carrying the mobile unit 6. In addition to the smart function, the vehicle unit 2, the mobile unit 6 and the road unit 4 communicate one another by transmitting and receiving radio signals thereamong, thereby performing a notification function to notify vehicle passengers of presence of a person carrying the mobile unit 6.

In performing the smart function, the vehicle unit 2 uses a low frequency (LF) band (134.2 kHz) to transmit radio signals to the mobile unit 6. The mobile unit 6 uses a first radio frequency band RF1 (e.g., 312.15 MHz) to transmit radio signals to the vehicle unit 2. The radio signal transmitted from the vehicle unit 2 to the mobile unit 6 by using the LF band is referred to as a smart request signal. Of the radio signals transmitted from the mobile unit 6 to the vehicle unit 2 by using the RF1 band, the radio signal transmitted in response to the request signal is referred to as a response signal (RF1), and a radio signal transmitted automatically is referred to as a notification signal.

In performing the notification function, the vehicle unit 2 uses a second radio frequency band RF2 (e.g., 313.40 MHz), which is different from the RF1 band of the response signal, to transmit radio signals to the mobile unit 6. The mobile unit 6 uses a third radio frequency band (RF3, e.g., 314.00 MHz), which are different from the RF1 band and RF2 band, to transmit radio signals to the vehicle unit 2. The road unit 4 uses the LF band, which is the same as that used in the smart function, to transmit the radio signals to the mobile unit 6.

The radio signal transmitted from the road unit 4 to the mobile unit 6 by using the LF band as a second request signal is referred to as a road-generated request signal. The radio signal transmitted from the vehicle unit 2 to the mobile unit 6 by using the RF2 band as the second request signal is referred to as a vehicle-generated request signal. The radio signal transmitted from the mobile unit 6 to the vehicle unit 2 by using the RF3 band is referred to as a presence notification signal.

The smart request signal and the vehicle-generated request signal, which are transmitted from the vehicle unit 2, and the road-generated request signal transmitted from the road unit 4 include at least identification data to identify which request signal it is. The response signal, notification signal and the presence notification signal, which are transmitted from the mobile unit 6, include at least additional data that specify details of control to be performed in the vehicle unit 2. The response signal and the presence notification signal include identification data, which are included in the signals that trigger transmission of the response signal and the presence notification signal.

The road unit 4 is configured as an electronic chip device and has a transmitter (LF transmitter) 4a, which periodically transmits the road-generated request signal at a fixed interval (fixed frequency) by using the LF transmitter 4a. The road unit 4 may include an infra-red light, etc., and be configured to transmit the road-generated request signal for a predetermined interval, when it detects the mobile unit 6 carried by a person, etc. within a predetermined detection area.

The mobile unit 6 includes a lock button 6a and an unlock button 6b for locking and unlocking vehicle doors. It further includes a receiver 61, a RF transmitter 62, a frequency switching circuit 63, and a controller 60. The receiver 61 and the transmitter 62 form a radio communication circuit. The receiver 61 includes a LF receiver 61a for receiving radio signals in the LF band and a RF receiver 61b for receiving radio signals in the RF2 band. The RF transmitter 62 transmits radio signals in the RF1 band and in the RF3 band. The switching circuit 63 switches over frequency bands, which are used to transmit the radio signals from the RF transmitter 62. The controller 60 controls communications with the vehicle unit 2 and the road unit 4 through the receiver 61 and the RF transmitter 62 based on operated condition of the lock button 6a and the unlock button 6b.

The controller 60 is configured to perform self-generated transmission processing and mobile unit control processing. In the self-generated transmission processing, a notification signal is generated voluntarily when the buttons 6a or 6b is operated. The notification signal includes additional data that specify controls to be performed in the vehicle according to the operated condition of the button 6a or 6b.

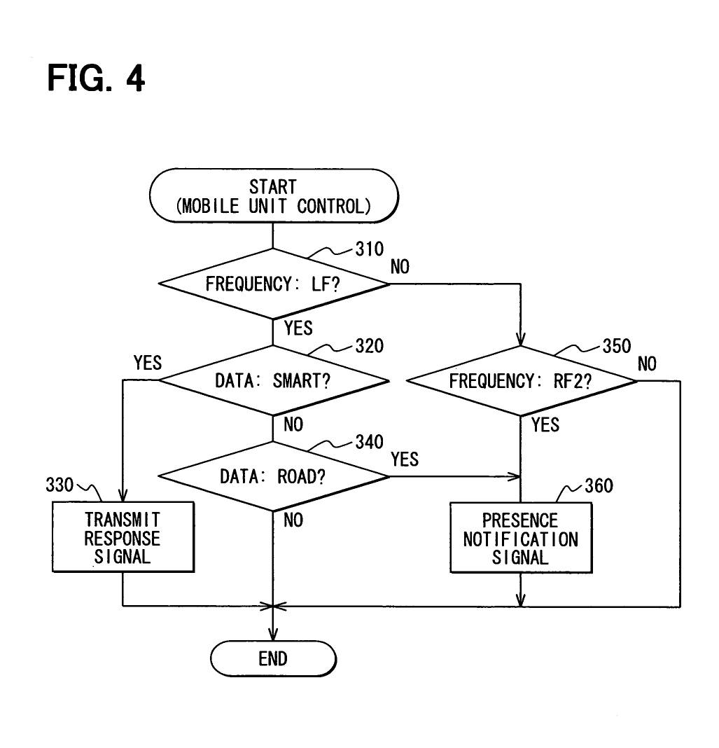

The controller 60 performs the mobile unit control processing as shown in FIG. 4. This processing is started each time the receiver 61 receives the radio signal from the vehicle unit 2 or the road unit 4.

At step 310, the controller 60 checks whether the frequency of the radio signal received by the receiver 61 is in the LF band. If it is in the LF band, the controller 60 checks at step 320 whether the received signal is the smart request signal transmitted from the vehicle unit 2 based on the identification data included in the received signal.

If it is the smart request signal, the controller 60 drives at step 330 the RF transmitter 62 to transmit the response signal to the vehicle unit 2. In step 330, specifically, the controller 60 forms the response signal to include the same identification data as the received smart request signal, and produces a switching instruction to the switching circuit 63 to switch over the frequency to be used by the RF transmitter 62 to the RF1 band. The controller 60 produces the formed response signal to the RF transmitter 62. The controller 60 drives the RF transmitter 62 to transmit the response signal in the RF1 band. Here, transmission of the response signal is performed by modulating a carrier wave in the RF1 band by the response signal.

If the received signal is not the smart request signal at step 320, the controller 60 checks at step 340 whether the received signal is the road-generated signal transmitted from the road unit 4 based on the identification data included in the received signal. If it is the road-generated signal, the controller 60 executes step 360. If it is not the road-generated signal, the controller 60 ends this processing.

If the received signal is not in the LF band at step 310, the controller 60 further checks at step 350 whether the received signal is in the RF2 band. If it is in the RF2 band, the controller executes step 360. If it is not in the RF2 band, the controller 60 ends this processing.

At step 360, the controller 60 drives the RF transmitter 62 to transmit the presence notification signal. In step 360, specifically, the controller 60 forms the presence notification signal by adding the identification data and the additional data. The identification data is the same as that included in the received road-generated request signal or the vehicle-generated request signal. The additional data indicates controls to be performed by the vehicle unit 2.

The controller 60 produces a switching instruction to the switching circuit 63 to switch over the frequency to be used by the RF transmitter 62 to the RF3 band. After this switching instruction, the controller 60 produces the formed presence notification signal to the RF transmitter 62. The controller 60 drives the RF transmitter 62 to transmit the presence notification signal in the RF3 band. Here, transmission of the presence notification signal is performed by modulating a carrier wave in the RF3 band by the presence notification signal.

As described above, for performing the smart function, the mobile unit 6 transmits the response signal in the RF1 band in response to the request signal transmitted from the vehicle unit 2 in the LF band. For performing the presence notification function, the mobile unit 6 transmits the presence notification signal in the RF3 band in response to the vehicle-generated request signal transmitted from the vehicle unit 2 in the RF2 band or the road-generated request signal transmitted from the road unit 4 in the LF band. The presence notification signal in RF2 or RF3 indicates a presence of a mobile unit owner. This mobile unit owner may be an actual user (passenger) of the vehicle that actually transmitted the vehicle-generated request signal or may be a pedestrian that happened to be present near the vehicle that transmitted the vehicle-generated request signal.

Referring to FIG. 1 again, the vehicle unit 2 includes a security ECU 10, a door ECU 20, a navigation ECU 30, a meter ECU 40, an engine ECU 50 and the like. The security ECU 10 is for mainly performing various vehicle control processing related to security of the vehicle. The door ECU 20 is for performing various controls related to the vehicle doors. The navigation ECU 30 is for controlling a navigation device and the like provided in front of a driver's seat in the vehicle compartment. The meter ECU 40 is for controlling a display and an indicator in an instrument panel of the vehicle. The engine ECU 50 is for controlling an engine.

These ECUs are connected one another through a communication line 3 to form an in-vehicle LAN. Each ECU including the security ECU 10 includes a microcomputer and associated electronic circuits, and controls the vehicle in a coordinated manner by performing data communication through the communication line 3 and sharing various information.

The meter ECU 40 is connected to a meter indicator 42, a multiple information (MI) display 44 and the like. The meter indicator 42 indicates various vehicle conditions such as vehicle travel speed, engine rotation speed, door open/close condition, and transmission shift position. The MI display 44 provides warnings of various systems in character messages on a single display screen. When the meter ECU 40 receives character message notification instruction from the security ECU 10 through the communication line 3, it performs processing for causing the MI display 44 to visually display such a notification in character message.

The navigation ECU 30 has both audio-visual function for reproducing CD data and DVD data and receiving FM/AM radio broadcasting. It is connected to a sound output device 32 for producing audible sounds, a display 34 for providing visual images, an operation device 36 for enabling various settings by manual operation of passengers, and the like. When the navigation ECU 30 receives the sound notification instruction from the security ECU 10 through the communication line 3, it drives the sound output device 32 to produce a instructed notification audibly. When the navigation ECU 30 receives the presence notification instruction, the navigation ECU 30 drives the display 34 to produce an instructed notification visually.

The door ECU 20 is connected to a touch sensor 22, a door lock switch 24, a door lock actuator (ACT) 26, an operation device 28 and the like. The touch sensor 22 is for detecting that a person touches a door handle provided on an outside of a driver's seat door. The door lock switch 24 is provided near the door handle of the driver's seat door. The door lock actuator 26 is for locking and unlocking the driver's seat door. The operation device 28 is for producing door lock and unlock instruction for the driver's seat door by manual operation. When the door ECU 20 receives a door lock control instruction from the security ECU 10 through the communication line 3, it drives the door lock actuator 26 to lock and unlock the door in response to the door lock control instruction.

The engine ECU 50 is connected to a group of sensors 52, an engine switch 54 and the like. The sensors 52 are for detecting various conditions including a wheel speed sensor required for engine control. The engine switch 54 is for instructing an engine start or stop manually. When the engine ECU 50 receives a start enabling instruction from the security ECU 10 through the communication line 3, it allows the engine switch 54 to be operated for engine starting. The engine ECU 50 then starts the engine when the engine switch 54 is turned to the START-position. The engine ECU 50 further controls engine operation based on detection results of the sensors 52.

The security ECU 10 is connected to a RF receiver 11, a RF transmitter 12, a frequency switching circuit 13, a LF door handle antenna 14, a mode setting switch 15 and an in-vehicle LF antenna 16. The RF receiver 11 is for receiving radio signals in the RF1 band and the RF3 band. The RF transmitter 12 is for transmitting radio signals in the RF2 band. The switching circuit 13 is for switching over the frequency bands of signals received and produced from the RF receiver 11. The mode setting switch 15 is for setting a mode of operation in the presence notification control. The antenna 14 is provided to be used when the radio signals in the LF band are transmitted toward the exterior of the vehicle. The antenna 16 is provided to be used when the radio signals in the LF band are transmitted toward the interior of the vehicle.

The security ECU 10 includes a LF transmitter 10b and a controller 10a. The LF transmitter 10b is for transmitting radio signals in the LF band through the LF door handle antenna 14 and the interior LF antenna 16. Thus, the LF transmitter 10b, the RF receiver 11 and the RF transmitter form a radio communication circuit in the vehicle unit 1. The controller 10a is for performing various controls by controlling the LF transmitter 10b, the RF receiver 11, the RF transmitter 12, the switching circuit 13 and the mode setting switch 15.

It is noted that the security ECU 10 is connected to the RF transmitter 12, the frequency switching circuit 13 and the mode setting switch 15 for performing the presence notification function, in addition to the conventional configuration of the RF receiver 11, the door handle antenna 14 and the interior LF antenna 16 for performing the smart function.

The controller 10a is configured to transmit to the ECUs 20 to 50 the door unlock instruction, the start enabling instruction, character message notification instruction, the sound notification instruction, the presence notification instruction and the like through the communication line 3 based on various data received through the communication line 3, the response signal and the presence notification signal received by the RF receiver 11.

The data received by the security ECU 10 through the communication line 10 include detection results of the touch sensor 22 and the door open/close switch 24 transmitted from the door ECU 20, and detection results of the sensors 52 including a vehicle speed and the operation condition of the engine switch 54 transmitted from the engine ECU 50.

The operation modes set by the mode setting switch 15 include an active mode (A-mode), a passive mode (P-mode), a combined mode (A&P-mode) and a prohibition mode. In the active mode, the presence notification signal is received by transmitting the vehicle-generated request signal. In the passive mode, only the presence notification signal is received. In the combined mode, both operations of the active mode and the passive mode are performed. In the prohibition mode, the presence notification control is prohibited.

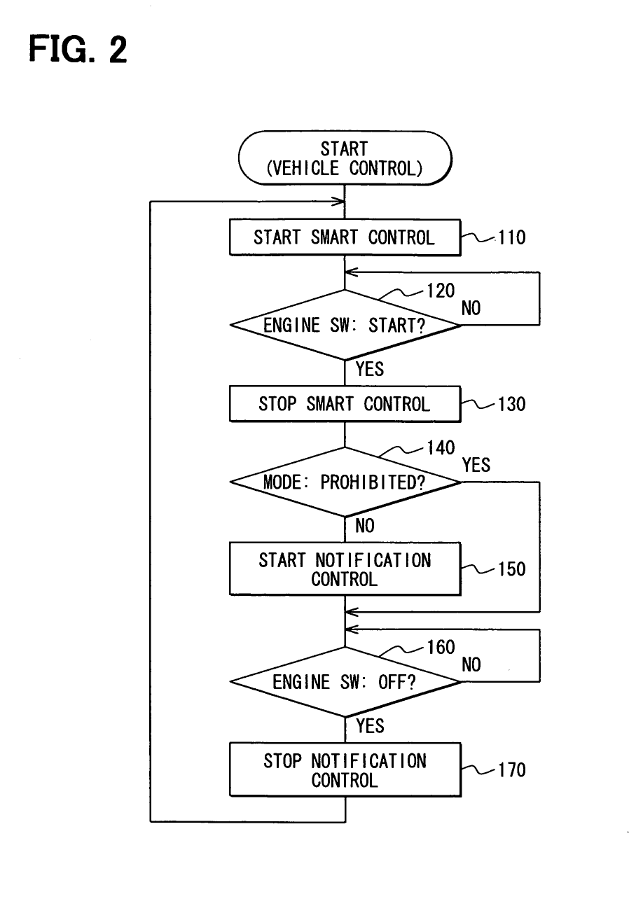

The controller 10a performs the vehicle control processing as shown in FIG. 2. This processing is repeatedly executed irrespective of starting or stopping of the engine, once started.

At step 110, the controller 10a starts the smart control processing, which includes unlocking of doors, enabling engine start by unlocking engine start locking device, in the similar manner as the conventional smart function. More specifically, in this smart control processing, the controller 10a outputs a switching instruction to the frequency switching circuit 13 so that the RF receiver 11 outputs the received signal in the RF1 band to the security ECU 10.

Under this condition, the controller 10a drives the LF transmitter 10b to periodically transmit the request signal outward from the LF door handle antenna 14. When the RF receiver 11 receives the response signal from the mobile unit 6 transmitted in response to the request signal, the controller 10a produces the door unlock instruction to the door ECU 20 so that the door is unlocked to be opened by the user carrying the mobile unit 6.

Then, the controller 10a drives the LF transmitter 10b to transmit the radio signal in the LF band from the interior LF antenna 16 into the vehicle compartment. When the RF receiver 11 receives the response signal from the mobile unit 6 transmitted in response to the request signal, the controller 10a transmits the start enabling signal to the engine ECU 50, so that the driver's operation on the engine switch 54 for engine starting is made acceptable.

The controller 10a acquires at step 120 information about the condition of the engine switch 54 from the engine ECU 50 through the communication line 3. The controller 10a then checks whether the operation on the engine switch 54 is made acceptable in the smart control processing of step 110 and the engine switch 54 is actually in the START-position.

If the operation on the engine switch 54 is not made acceptable or the engine switch 54 is not in the START-position, step 120 is repeated. During the repetition of step 120, i.e., during a wait period, the controller 10a continues to perform the smart control function. If the operation on the engine switch 54 is made acceptable and the engine switch 54 is in the START-position, the controller 10a determines that the engine is in operation and executes step 130 to stop the smart control processing initiated at step 110.

The controller 10a then checks at step 140 whether the mode set by the setting switch 15 is the prohibition mode. If it is not the prohibition mode, the controller 10a starts the presence notification control processing for assisting vehicle driving at step 150 to notify the passenger in the vehicle of presence of a person or the like, who is outside the vehicle and carries a mobile unit 6 which is similar to that actually used in driving the vehicle. If the mode is the prohibition mode at step 140, the controller 10a executes step 160 without executing step 150.

The controller 10a acquires information about the condition of the engine switch 54 and checks at step 160 whether the engine switch 54 is actually in the OFF-position. If the engine switch 54 is not in the OFF-position, the controller 10a repeats step 160 and waits until the engine switch 54 is turned to the OFF-position. During this wait period, the presence notification processing started at step 150 is continued. If the engine switch 54 is in the OFF-position, the controller 10a determines that the engine operation is stopped and stops the presence notification control processing at step 170, thus returning to step 110. Thus, the controller 10a performs the smart control processing during the engine stop and the presence notification control processing during the engine operation.

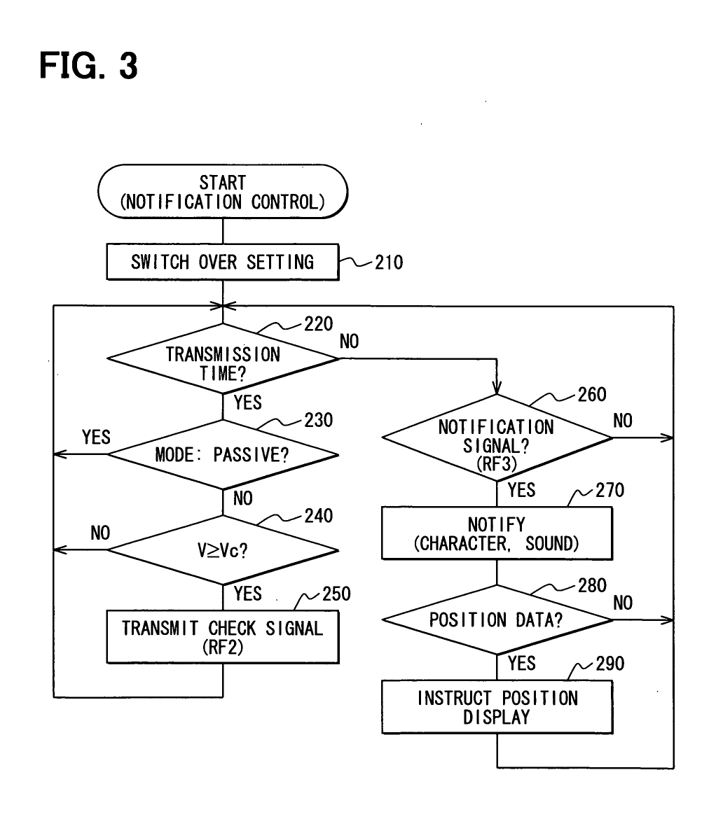

The presence notification control processing of step 150 is performed as shown in FIG. 3.

In this processing, first at step 210, the controller 10a produces a switching instruction to the frequency switching circuit 13 so that the RF receiver 11 produces the received signal in the RF3 band to the controller 10a. The controller 10a further produces to the meter ECU 40 an instruction for displaying the operation mode set by the mode setting switch 15. The MI display 44 thus displays the operation mode of the presence notification control processing.

At subsequent step 220, the controller 10a checks whether it is the time to transmit the vehicle-generated request signal. If it is the time, the controller 10a executes step 230. The transmission time is set to occur at a predetermined time interval after processing of step 210. This time interval may be fixed or variable in accordance with the vehicle speed. The time interval may be shortened as the vehicle speed increases. The time interval may also be set manually by the user.

At step 230, the controller 10a checks whether the operation mode set by the setting switch 15 is the P-mode. If it is the A-mode or the A&P-mode, and not the P-mode, the controller 10a executes step 240. In this step 240, the controller 10a acquires the vehicle speed V from the engine ECU 50 and checks whether the vehicle speed V is equal to or higher than a predetermined reference speed Vc. This reference speed Vc is set to a threshold for determining whether the vehicle is moving or not. If the vehicle speed V is higher than reference speed Vc, the controller 10a drives the RF transmitter 12 to transmit the vehicle-generated request signal and then returns to step 220.

If the operation mode is the P-mode at step 230, or the vehicle speed V is lower than the reference speed Vc indicating that the vehicle is not moving at step 240, the controller 10a executes step 220 again.

If it is not the time of transmission of the request signal at step 220, the controller checks at step 260 whether the RF receiver 260 received the presence notification signal from the mobile unit 6. If the presence notification signal is not received, the controller 10a repeats step 220 again. If it is received, the controller 10a produces at step 270 an instruction of a visual character message notification or an audible sound notification to the navigation ECU 30 and the meter ECU 40, so that the presence of the mobile unit 6 which is a source of transmission of the presence notification signal may be informed. The meter ECU 40 thus drives the MI display 44 to display this information visually and the navigation ECU 30 drives the sound output device 32 to generate audible alarm sound or the like in the vehicle.

At step 280, the controller 10a checks whether the received presence notification signal includes position data, that is, whether it is the presence notification signal generated in response to the road-generated request signal. If the position data is not included, the controller 10a executes step 220 again. If it is included, the controller 10a produces at step 290 a position notification instruction to the navigation ECU 30, and executes step 220 again. The navigation ECU 30 indicates the position specified by the position data on the map provided on the display 34.

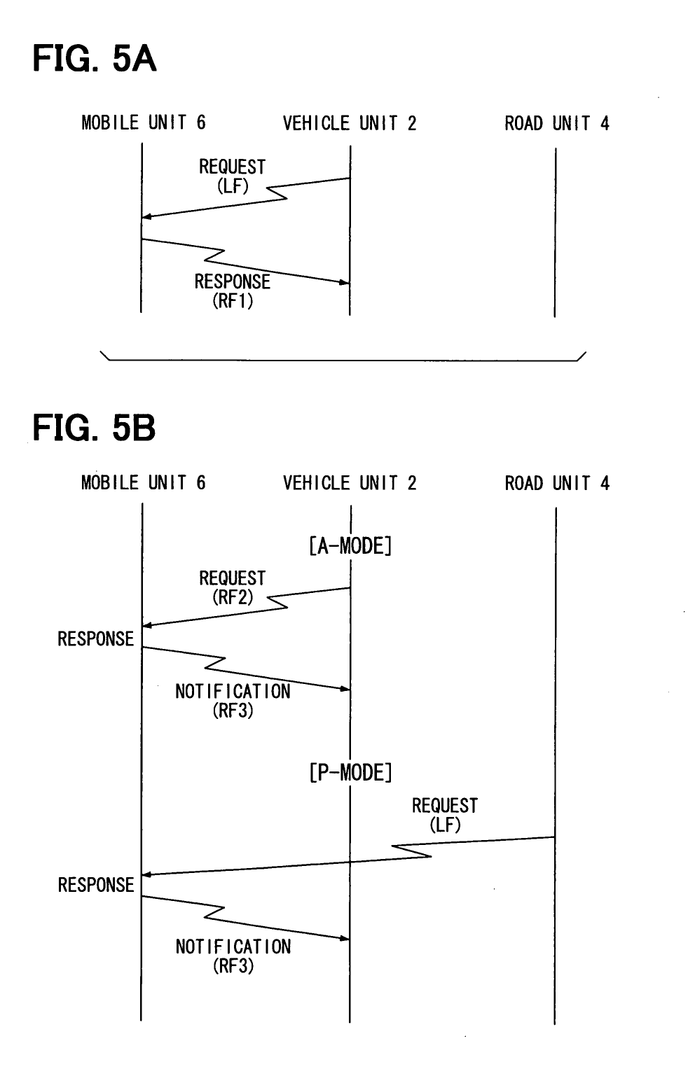

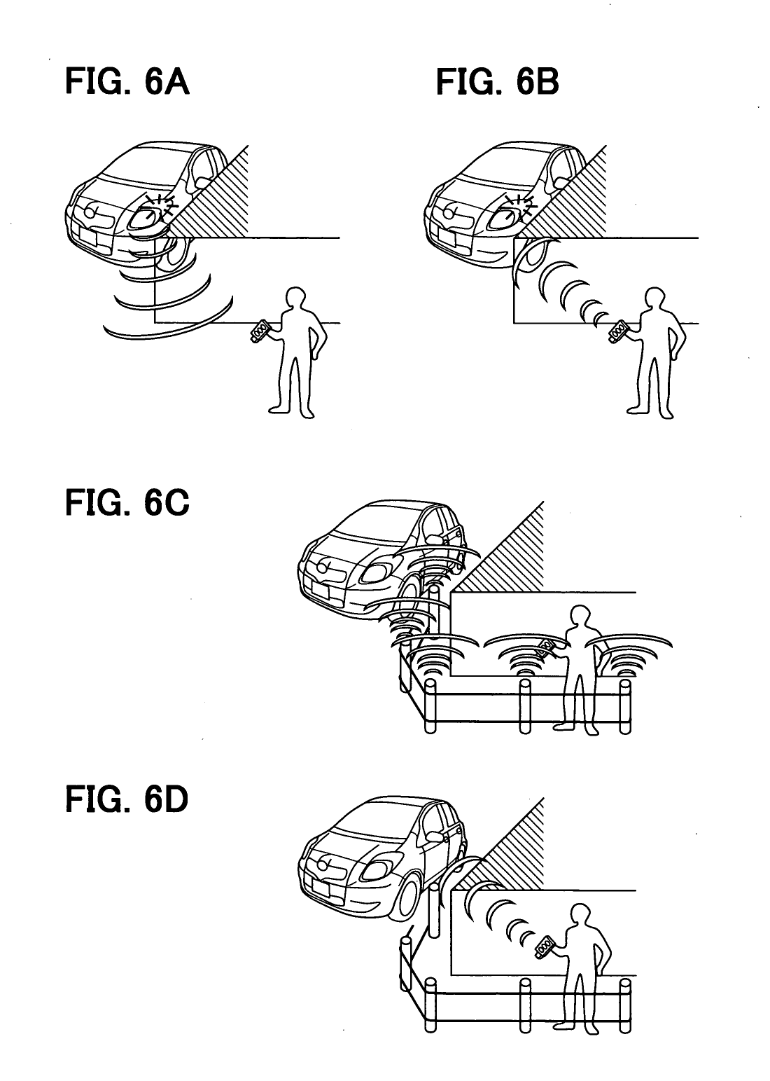

The first embodiment operates as follows and as shown in FIGS. 5A, 5B and 6A to 6D.

While the engine is at rest and not operating, the vehicle unit 2 executes the smart control processing by transmitting periodically the request signal in the LF band as shown in FIG. 5A. The request signal includes identification data (for example, “AMA”) to indicate that this request signal is transmitted in the smart control processing.

The mobile unit 6 carried by a user transmits the response signal in the RF1 band in return to the received request signal. The response signal also includes the same identification data (for example, “AAAA”) to indicate that this response signal is a response to the request signal including the identification data AAAA.

The vehicle unit 2, receiving the response signal, checks whether the response signal is transmitted from the authorized mobile unit 6 by analyzing the information included in the response signal. If the mobile unit 6 is the authorized one, the vehicle unit 2 unlocks the door lock mechanism and the engine start lock mechanism to enable engine starting. When the engine switch 54 is operated and the engine is started, the smart control processing is terminated. After the engine is started, the vehicle unit 2 starts the presence notification control processing.

As shown in FIG. 5B, if the mode setting switch 15 sets the operation mode to either the A-mode or the A&P-mode, the vehicle unit 2 transmits periodically the vehicle-generated request signal by using the RF2 band as shown in FIG. 6A. This request signal includes identification data (for example, “ABAB”) to indicate that this request signal is transmitted from the vehicle unit 2 in the presence notification control processing different from the smart control processing.

When the mobile unit 6 receives the vehicle-generated request signal, it transmits the presence notification signal by using the RF3 band as shown in FIG. 6B. This presence notification signal also includes the same identification data (for example, “ABAB”) to indicate that this presence notification signal is a response to the vehicle-generated request signal including the identification data ABAB. The vehicle unit 2, receiving the presence notification signal, provides a notification visually in character message and audibly by alarm sound.

If the operation mode is the P-mode, the vehicle unit 2 does not transmit any vehicle-generated request signals but waits for the presence notification signal from the mobile unit 6. In this mode, it is only possible that the vehicle unit 2 receives the road-generated request signal from the road unit 4 as shown in FIG. 6C. This request signal is transmitted by using the LF band from the road unit 4 embedded in the road-side fixture such as guardrails provided along travel roads. This request signal may be transmitted periodically or in response to a detection of a person or the like by a sensor.

The road-generated request signal includes an identification data (for example, “ACCA”) to indicate that this request signal is transmitted from the road unit 4 in the presence notification processing. The road-generated request signal also includes the position data indicating the position of installation of the road unit 4.

When the mobile unit 6 receives the road-generated request signal, it transmits the presence notification signal by using the RF3 band as shown in FIG. 6D. This presence notification signal also includes the same identification data (for example, “ACCA”) and the position data to indicate that this presence notification signal is a response to the road-generated request signal including the identification data ACCA and the position data.

The vehicle unit 2, receiving this presence notification signal, provides not only the visual notification and the audible notification but also the position indication on the map of the navigation display screen based on the position data included in the received presence notification signal.

According to the first embodiment, the vehicle unit 2 performs the smart control processing while the engine is not operated, by transmitting the smart request signal and receiving the response signal from the mobile unit 6. Further, the vehicle system performs the presence notification control processing to notify the presence of a person holding a similar mobile unit near the vehicle while the engine is operated, by receiving the presence notification signal transmitted from the mobile unit in response to the vehicle-generated request signal or the road-generated request signal.

Thus, the RF receiver 11 of the vehicle unit 2 as well as the RF receiver 61 and the RF transmitter 62 of the mobile unit 6 are used for performing both the smart function in the engine stop condition and the presence notification function in the engine operation condition. As a result, these component parts can be used efficiently and a space for installing component parts of the system need not be increased.

In addition, the road-generated request signal transmitted from the road unit 4 includes the position data and the mobile unit 6 transmits the presence notification signal including the position data to the vehicle unit 2. Further, the road-generated request signal is transmitted by using the LF band, which is limited to a narrow communication range, so that it is transmitted only within a short range around the road unit 4. As a result, the vehicle unit 2 can notify the driver of not only the presence of the mobile unit but also the position of the pedestrian.

Still further, the mobile unit 6 uses the RF band, which has a long communication range, for transmitting the presence notification signal. As a result, the mobile unit 6 can notify the driver of the presence of the mobile unit from the remote position from the vehicle.

### Second Embodiment

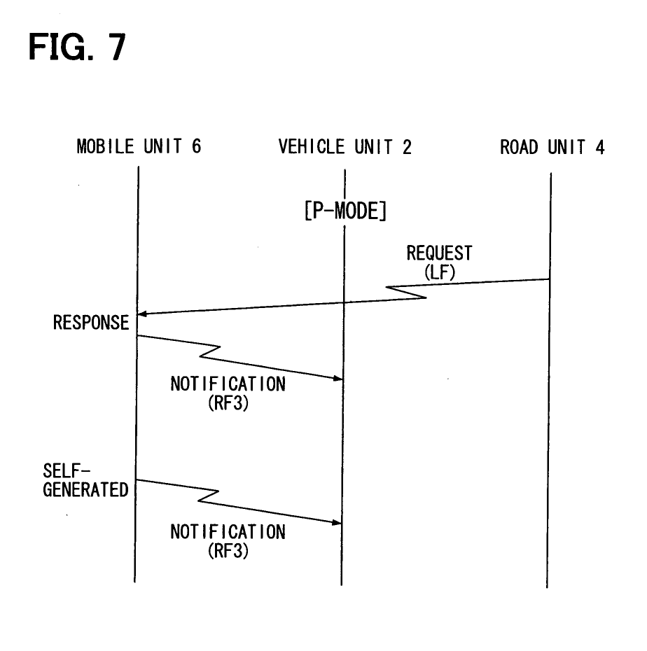

In the second embodiment, the mobile unit 6 not only transmits the presence notification signal in response to the vehicle-generated request signal or the road-generated request signal, but also transmits the presence notification signal voluntarily and periodically as a self-generated notification signal after transmitting the response signal as shown in FIG. 7. Since the second embodiment is different from the first embodiment only in respect of the operation of performing the presence notification control processing in the P-mode. Therefore FIG. 7 shows only this different part.

As shown in FIG. 7, after responding to the road-generated request signal as in the first embodiment, the mobile unit 6 voluntarily transmits the presence notification signal by using the RF3 band. This presence notification signal is assigned with the identification data (for example, “ACAC”) to indicate that it is a self-generated notification signal. If the mobile unit 6 has a GPS function, position data may be preferably added in addition to the identification data.

The vehicle unit 2, receiving this presence notification signal, provides a character message display and an alarm sound to notify the presence. If the position data is included in the received notification signal, the vehicle unit 2 also indicates the position on the navigation display 34.

According to the second embodiment, since the mobile unit 6 voluntarily transmits the presence notification signal, the vehicle unit 2 can be operated in the P-mode even at places where no road units 4 are provided.

It is noted that the vehicle unit 2 may be configured to operate only in the P-mode without operating in the A-mode. In this case, the RF transmitter 12 of the vehicle unit 2 and the RF receiver 61b of the mobile unit 6 need not be provided. Therefore, the configuration of the vehicle control system 1 can be simplified and the control processing by the vehicle unit 2 and the mobile unit 6 can be reduced.

### Other Embodiments

Various modifications and alterations may be made to the embodiments.

For instance, the vehicle control system 1 may be configured with only the vehicle unit 2 and the mobile unit 6 without any road units 4. In this case, since the mobile unit 6 need not check whether the signal received by the LF receiver 61a is the smart request signal or the road-generated request signal, the control processing by the mobile unit 6 can be reduced.

The display device for providing visual notifications to passengers of the vehicle is not limited to the MI display 44 but may use the display device 34 or the like connected to the navigation ECU 30. The sound output device for providing audible notifications to passengers of the vehicle is not limited to the sound output device 32 of the navigation ECU 30, but may use another sound output device by directly connecting it to the security ECU 10.

The interval of locations of embedding the road units 4 in roads, guardrails and the like and the time points of transmitting signals of the same may be determined arbitrarily in accordance with the positions where the road units 4 are installed.

What is claimed is:

1. A vehicle control system comprising a mobile unit and a vehicle unit, wherein the mobile unit includes:
mobile-side communication means for performing radio communications with the vehicle unit;
response means for transmitting a predetermined response signal through the mobile-side communication means when receiving a predetermined request signal through the mobile-side communication means; and
presence notification means for transmitting a presence notification signal different from the response signal through the mobile-side communication means when a predetermined notification condition is satisfied, and wherein the vehicle unit includes:
vehicle-side communication means for radio communication with the mobile unit;
vehicle control means for transmitting the request signal through the vehicle-side communication means when a predetermined operation condition is satisfied, and performing predetermined vehicle control when receiving the response signal in response to the request signal; and
notification means for performing a notification corresponding to the presence notification signal when receiving the presence notification signal through the vehicle-side communication means while the predetermined operation condition is not satisfied.

2. The vehicle control system according to claim 1, wherein:
the predetermined operation condition includes an engine stop condition.

3. The vehicle control system according to claim 1, wherein:
the predetermined notification condition includes reception of another request signal different from the predetermined request signal through the mobile-side communication means.

4. The vehicle control system according to claim 3, further comprising:
a road unit provided in a fixture near a vehicle travel road and including transmission means for transmitting the another request signal.

5. The vehicle control system according to claim 3, wherein:
the notification means transmits the another request signal through the vehicle-side communication means.

6. The vehicle control system according to claim 5, wherein:
the notification means transmits the another request signal through the vehicle-side communication means when a vehicle speed is higher than a predetermined reference speed.

7. The vehicle control system according to claim 3, wherein:
the predetermined request signal and the another request signal are transmitted and received by using different frequencies from each other.

8. The vehicle control system according to claim 3, wherein:
the predetermined request signal and the another request signal include respective identification data to be differentiated from each other.

9. A mobile unit comprising:
mobile-side communication means for performing radio communications;
response means for transmitting a predetermined response signal through the mobile-side communication means when receiving a predetermined request signal through the mobile-side communication means; and
presence notification means for transmitting a presence notification signal different from the response signal through the mobile-side communication means when a predetermined notification condition is satisfied.

10. The mobile unit according to claim 9, wherein:
the predetermined notification condition includes reception of another request signal different from the predetermined request signal through the mobile-side communication means.

11. The mobile unit according to claim 10, wherein:
the predetermined request signal and the another request signal have different frequencies.

12. The mobile unit according to claim 10, wherein:
the another request signal has identification data to be used to differentiate from the predetermined request signal.

13. A vehicle unit comprising:
vehicle-side communication means for radio communication;
vehicle control means for transmitting a predetermined request signal through the vehicle-side communication means when a predetermined operation condition is satisfied, and performing predetermined vehicle control when receiving a response signal in response to the predetermined request signal; and
notification means for performing a notification corresponding to a presence notification signal when receiving the presence notification signal through the vehicle-side communication means while the predetermined operation condition is not satisfied.

14. The vehicle unit according to claim 13, wherein:
the predetermined operation condition includes an engine stop condition.

15. The vehicle unit according to claim 13, wherein:
the notification means transmits another request signal different from the predetermined request signal through the vehicle-side communication means.

16. The vehicle unit according to claim 15, wherein:
the notification means transmits the another request signal through the vehicle-side communication means when a vehicle speed is higher than a predetermined reference speed.

17. The vehicle unit according to claim 15, wherein:
the predetermined request signal and the another request signal are transmitted and received by using different frequencies from each other.
